(19) United States
(12) Patent Application Publication
(10) Pub. No.: US 2003/0133473 A1
(43) Pub. Date: Jul. 17, 2003

(54) Power line communication system

(76) Inventors: Constantine N. Manis, Monmouth Junction, NJ (US); Oleg Logvinov, East Brunswick, NJ (US); Dick J. Walvis, Santa Cruz, CA (US); Brion J. Ebert, Easton, PA (US)

Correspondence Address: L.P. Brooks, Esq., Norris, McLaughlin & Marcus, 721 Route 202-206, P.O. Box 1018, Somerville, NJ, 08876-1018, US

(21) Appl. No.: 10/211,759

(22) Filed: Aug. 2, 2002

Related U.S. Application Data
(60) Provisional application No. 60/310,300, filed on Aug. 4, 2001.
(60) Provisional application No. 60/310,132, filed on Aug. 4, 2001.

(51) Int. Cl. H04J 11/00; H04M 11/04; H04B 7/208; H04M 9/00; H04J 1/00

(52) U.S. Cl. 370/480; 370/344; 370/208; 340/310.01; 455/402

(57) ABSTRACT

Power line communication method and apparatus in which data modulated radio frequency carriers from two different sources are transmitted by the power line, the range of frequencies of the carriers from one source partially overlapping the range of frequencies of the carriers from the other source, and in which carriers of the one source are shifted to frequencies other than the overlapping frequencies when carriers at the overlapping frequencies and from the other source are present on the line. Optionally, the data signal sampling rate can be changed to simplify signal filtering requirements.

### RELATED APPLICATIONS

The benefit of priority of Provisional Patent Application Nos. 60/310,300 and 60/310,132, both filed on Aug. 4, 2001 in the names of the inventors named herein, is claimed.

### FIELD OF THE INVENTION

The invention relates to communication systems using radio frequency carriers and, particularly, to communication systems in which electrical power lines, i.e., electrical conductors which transmit electrical energy in the voltage range of 100-300 rms volts at frequencies from 20-100 cycles per second to energize home appliances such as lights, heating, ventilating and air conditioning equipment (HVAC), refrigerators, television sets, etc., also are at least part of the transmission medium for the information to be communicated, e.g., the digital signal output of communication apparatus.

### BACKGROUND OF THE INVENTION

As used herein, the acronyms and abbreviations have the following meanings:

| | |
|---|---|
| AFE | Analog Front End |
| BPSK | Binary Phase Shift Keying |
| FEC | Forward Error Correction |
| FFT | Fast Fourier Transform |
| IFFT | Inverse Fast Fourier Transform |
| LPF | Low Pass Filter |
| LV | Low Voltage |
| MAC | Media Access Controller |
| OFDM | Orthogonal Frequency Division Multiplexing |
| QPSK | Quadrature Phase Shift Keying |
| ROBO | Robust Ofdm (Modulation and Encoding Technique) |

A “legacy” system is another communication system, usually pre-existing, which uses power lines as the transmission medium.

Although the principles of the invention can be used in connection with other communication systems, the invention will be described in connection with the power line communication systems of the type developed by Enikia, Inc. in New Jersey and described at pages 100-107 of the publication entitled “The Essential Guide to Home Networking Technologies” published in 2001 by Prentice Hall, Inc., Upper Saddle River, N.J., described in copending applications filed Jun. 28, 2000 and entitled Method for Changing Signal Modulation Based on an Analysis of Powerline Conditions, and Method for Selecting and Changing Gears in Powerlines Networks, the disclosures of the copending applications being incorporated herein by reference.

Numerous powerline communication systems are described in the patents identified in the copending U.S. application No. 09/290,255.

There exist today many forms and types of networks, both wired and wireless, that allow for high speed data communication. The common thrust of all of these networks is to provide communication between devices, as well as access the Internet. On the other hand, the common problem with many of these networks is that they have to be deployed, which can be very costly and time consuming just to set up the network infrastructure. In recent years there has been substantial interest in coming up with a way of communicating at high speeds and at high data rates over AC power lines. Power lines are advantageous because the network is already in place and is available to almost every home and business in the world.

However, power lines and power transmission networks suffer from some other significant problems, most notably noise and inconsistent impedance. Power line communication is not a new concept, and there have been various methods and technologies that have been developed to allow for reliable communication. One such method that can be used for broadband communication is OFDM (Orthogonal Frequency Division Multiplexing). This allows for the use of a large number of closely spaced carriers to transmit data across the line. This carrier multiplexing along with the use of data interleaving and FEC coding provide a robust and reliable communication method to overcome the inherent problems of a power line.

When looking at a common power transmission network, it can be broken up into three (3) main segments. From a standard power substation, there is commonly a “distribution” network of medium voltage power lines, configured in a loop and several miles in length, that feed out to an area of homes and businesses. Then at various points on the loop there exist step down transformers that provide a series of 110 -240 V “access” lines depending on the country to a small number of homes and/or businesses. At the end of each one of these lines there is typically a meter or meters present for each electricity customer served by that line. Then on the other side of each meter there exists a typical “in-home” electricity distribution network inside a home or business.

It can be seen that all three of the network segments could possibly be used to transmit data across. However, it can be said that the “access” and “in-home” segments of this network are adjacent networks, with only an electricity meter in between. Also, it is very likely that the data transmitted on each of these segments will be for different purposes and have different destinations. For example, data transmitted on the access network segment could have multiple destinations or could be available to all end points, whereas data on an in-home network would likely be internal to that home or business. Therefore it would seem advantageous to logically separate these network segments to allow for separation and protection of data traveling on each segment. One possible method of accomplishing this would be to allocate different frequency ranges for each segment. This would allow for separation and also non-interference between segments.

A problem may arise, however, in this arena where there exists a legacy system in place, operating in a certain frequency range, and there is a desire to add communication on another network segment. In this case the legacy system may have to disable some of its carriers to allow for bandwidth allocated to the new system, thus diminishing its own bandwidth. However the legacy system may not allow for this. It is also conceivable that the legacy system could be shifted up or shifted down in frequency to accommodate, but this would most likely require a change to the hardware and also would no longer allow it to communicate with other units of the same type. There is also the possibility of using blocking filters to isolate the network segments, but this would add extra expense and installation cost and may not be advantageous for many applications. The goal of this invention is to solve this problem without sacrificing use of legacy system and preserving its bandwidth as much as possible.

There exist today a number of communication networks that operate over a broad band and at high speeds. These networks may operate on different mediums and different frequency ranges, but they all must comply to a certain radiation limit as well as other limits that may be imposed based on other devices or networks operating in the same frequency range. Due to the broadband nature of these networks, it is likely that there will be areas of the frequency band that cannot be used due to other communication devices occupying these areas. A common example of this would be amateur radio bands that occupy certain frequencies throughout the RF radio spectrum. This may require filtering notches to be put in place throughout a broadband communication system's operating frequency range. Another common requirement at the edges of this range is to have a steep roll off in transmitted power and be able to comply to a certain power spectral density limit beyond the edges of the operating frequency range. This often contributes to additional high-order filters being added to the design.

These high-order filter requirements can make the design of an analog front end very complicated, very large, and therefore very costly. In order to keep these issues in check, and to still satisfy the filtering requirements, it may be advantageous to increase the sampling frequency of the analog front end. This will often allow for simplifying of the filter designs as well as improved resolution on the received signal.

### BRIEF SUMMARY OF INVENTION

This invention overcomes the problems associated with the following scenario: (1) there exists a plurality of devices connected to adjacent network segments operating within the same or adjacent frequency ranges, and (2) there exists a number of legacy devices that may encroach the frequency range of new adjacent segment devices, and (3) there is a desire to communicate using the legacy system protocol without sacrificing substantial bandwidth and still allowing for non-interference with the new adjacent segment devices.

The basic concept of this invention is the ability to re-map a number of carriers in an existent OFDM or other multi-carrier system to another area of available frequency range, thus allowing for the availability of a certain frequency range to another adjacent network, while still preserving the bandwidth of the existent system to invention enabled devices, as well as the ability to still communicate with other compliant devices.

A modification to this invention overcomes the main issues associated with designing an analog front end for a broadband communication system in which: (1) there exists a number of frequencies or frequency bands in the overall frequency range that would need to be filtered out from transmitting or receiving due to other devices operating in these frequencies, and (2) there exists power spectral density limits that must be complied with both at the operating limits for the frequency band as well as at the filtered notches, and (3) there is a desire to reduce the complexity and the cost of the analog front end as much as possible. The basic concept of this invention is the idea of increasing the sampling rate of the analog front end above what the communication protocol may be designed to. This, in many cases, will allow the filtering designs to be simplified and cost reduced, as well as allowing for greater resolution on the received signals.

### BRIEF DESCRIPTION OF THE DRAWINGS

The present invention will be subsequently described ftuther with reference to the accompanying diagrams in which:

FIG. 1 is a schematic diagram of a typical power line network with adjacent segments;

FIG. 2 is a simplified block diagram of a prior art, power line, communication system of the type developed by Enikia, Inc.;

FIG. 3 is a graph of the carrier frequency range of a prior art legacy OFDM system;

FIG. 4 is a graph of an adjacent network carrier frequency range in relation to the graph of FIG. 3;

FIG. 5 is a graph of the available frequency range in relation to the legacy OFDM system;

FIG. 6 is a graph illustrating the re-mapping of certain carriers into the available frequency range;

FIG. 7 is a graph illustrating the possible operation modes in relation to carriers used for invention enabled devices;

FIGS. 8 and 9 are block diagrams illustrating modifications of the prior art system of FIG. 2 for the purposes of the invention;

FIG. 10 is a graph illustrating an example of a transmit spectrum mask for a broadband communication system;

FIG. 11 is a table showing the power spectral density limits for the spectrum illustrated in FIG. 10; and

FIGS. 12 and 13 are simplified block diagrams illustrating modifications of the transmitter and receiver systems illustrated in FIG. 2 for the purposes of the invention.

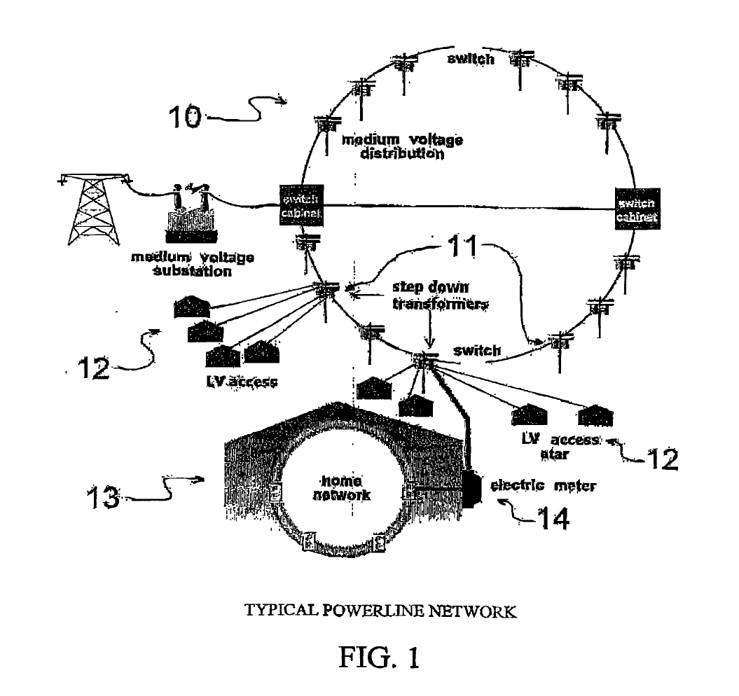

FIG. 1 illustrates a typical electrical distribution network showing its three (3) main network segments. The access star network and in-home network are deemed to be the areas where the preferred embodiment of this invention would be utilized. It is in this situation where the two network segments can likely see, and therefore interfere with, each other if communication devices should happen to be using the same frequency range to transmit data. This problem is also possible if there exist legacy devices installed on one segment of the network, and then at some point later communication devices are installed on the adjacent segment that may utilize a portion of the legacy frequency bandwith. There would normally be an electrical meter separating the two segments, however it would be very likely that signals transmitted on one network segment can be seen on the opposing side.

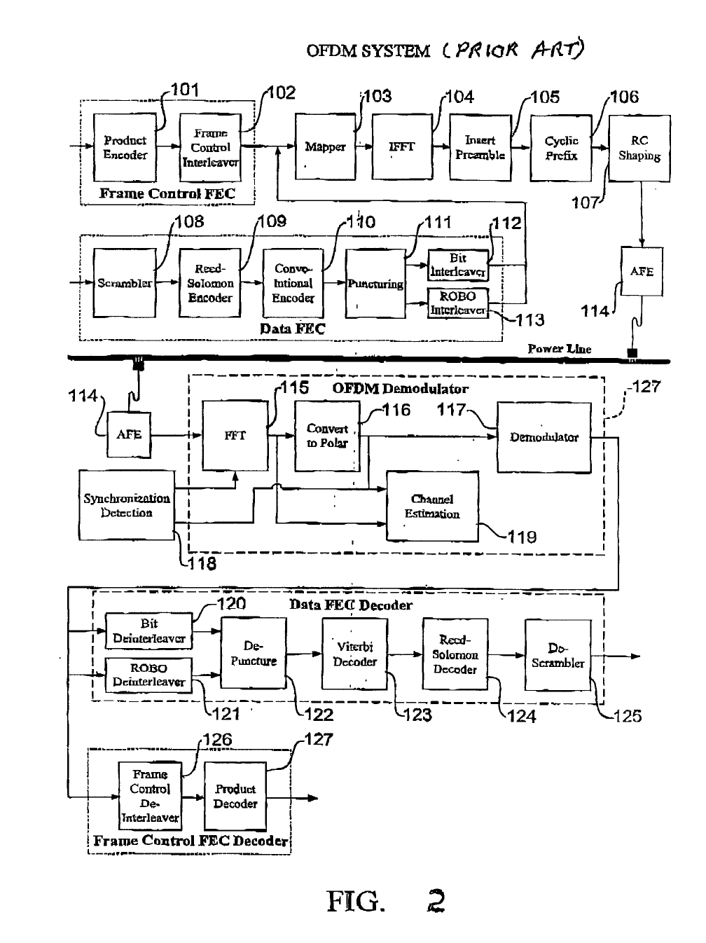

There exists prior art of an OFDM system as shown in FIG. 2. This system consists of a processing chain in the transmitter that transforms the raw data (bits) at the input into an OFDM format that will be transmitted across the power line. At the other side, the receiver takes the OFDM transmission off of the medium and transforms it back into the original raw data. This particular OFDM system has two data paths, in which the data is prepared differently for transmission. One path is known as the frame control path, which carries control information, as well as information about the data being sent. The receiver basically uses this information to prepare itself to receive the actual data that will follow correctly. The other path is for the actual data that is to be transmitted across the power line. The major processing block pairs (the block in the transmitter and the block in the receiver that perform the opposite functions) will be described further below.

Scrambler/Descrambler

The scrambler 108 basically helps to give the data a random distribution. This aids in distributing the data and therefore the transmitted power across the band. The descrambler 125 works to reorganize the data back to its original form.

Puncturing/Depuncturing

Puncturing 111 can be used as an option to take out extra bits of redundancy in the data inserted by the FEC encoders to reduce the number of bits that need to be transmitted. This can serve to decrease the overhead incurred by the error correction modules if desired. Depuncturing 122 restores the extra bits for proper decoding by the FEC modules in the receiver.

Encoder/Decoder Pairs

The encoder is part of the FEC (Forward Error Correction) process. The encoder basically arranges the data bits so that any errors that may occur during transmission can be corrected by the decoder. Some OFDM systems use several different types of FEC processes, as with this system, with an encoder and a decoder for each. This system consists of a reed-solomon encoder 109 with a reed-solomon decoder 124, as well as a convolutional encoder 110 with a viterbi decoder 123. FEC methods can work on a block of data, or can work on the data in a serial format (1 bit at a time). Use of multiple types of FEC will increase the robustness of a communication system. The decoder can normally correct a number of errors in a transmission, but does have a maximum limit.

Interleaver/Deinterleaver

The interleaver and deinterleaver pair work to assign and extract respectfully, the data bits to and from the OFDM carriers. The data is effectively distributed to all of the available carriers of the system. This OFDM system uses two different interleavers/deinterleavers, depending on the desired transmission type. Only one is used for each transmission. The ROBO interleaver 109, ROBO deinterleaver 121 pair is used when the channel is difficult to communicate across, for it transmits data at a lower bits per carrier rate with increased redundancy of data. The bit interleaver 112/deinterleaver 120 pair is used when a cleaner channel is present, and performs higher orders of modulation. Frame Control Encoder 101/Decoder 127, Interleaver 102/Deinterleaver 126. These modules perform the same tasks as described in the data path, however there is more replication and redundancy performed here to increase the robustness of the frame control transmission.

Mapper/Demodulator

The mapper 103 actually maps the carriers that will be used for a transmission to the frequencies that will be modulated. The block of data bits is converted to vectors of complex numbers. Based on the modulation method of all the carriers (ROBO, BPSK, QPSK), the mapper maps the data bits onto the constellation points for each carrier. The result is a complete set of vectors for an OFDM symbol. On the receiver side the demodulator 117 will convert the vectors back to a set of bits.

IFFT/FFT and Remaining Modules

The IFFT block 104 then performs the actual modulation of the constellation points onto the carrier waveforms. Basically vectors in the frequency domain are converted to a waveform in the time domain. After the IFFT is performed, the cyclic prefix is added and digital waveform is converted to an analog signal for transmission. At the other end the receiver will sample the medium until it detects the proper waveforms, and then convert these waveforms to digital samples that an FFT 115 is performed on. A synchronization block 118 is normally used to line up the FFT 115 to the correct set of samples for conversion back to the frequency domain to demodulate. A channel estimation block 119 is also used in the receiver to determine the channel quality at any point in time. This information is then relayed back to a requesting transmitter to determine what modulation method is possible to that receiver for future data transmissions. The AFE 114 (analog front end) is used to convert digital to analog and back again, as well as provide filtering.

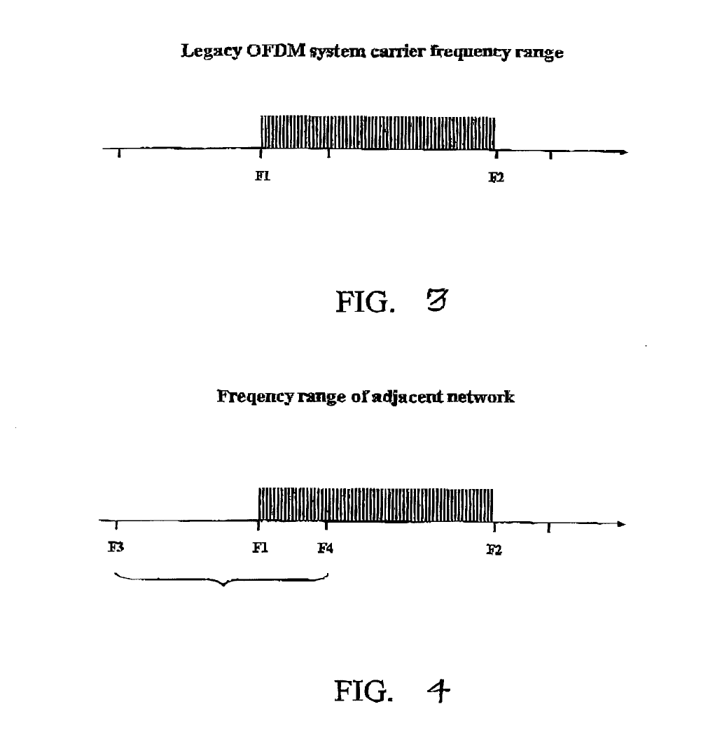

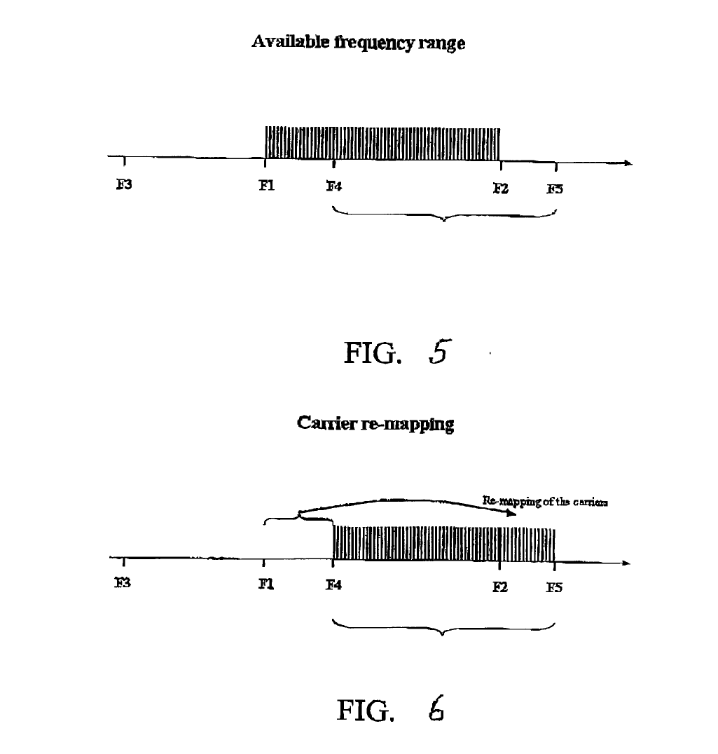

The assumed scenario for this invention is that there is a different frequency band allocated for each network segment. Additionally, the assumption is that the newly installed communication devices comply with this allocation but the legacy system devices may or may not comply or may comply by disabling a number of carriers that would be interfering. FIG. 3 shows a carrier frequency band that a legacy device would be using to transmit and receive data. This frequency range is shown to be between frequency F1 and frequency F2. In FIG. 4 it is shown that there is a frequency range allocated to the adjacent network segment that is between frequency F3 and frequency F4. It can be seen that there are a number of carriers between F1 and F4 that are being used by the legacy device but are allocated to the adjacent network segment.

### INVENTION ENABLING

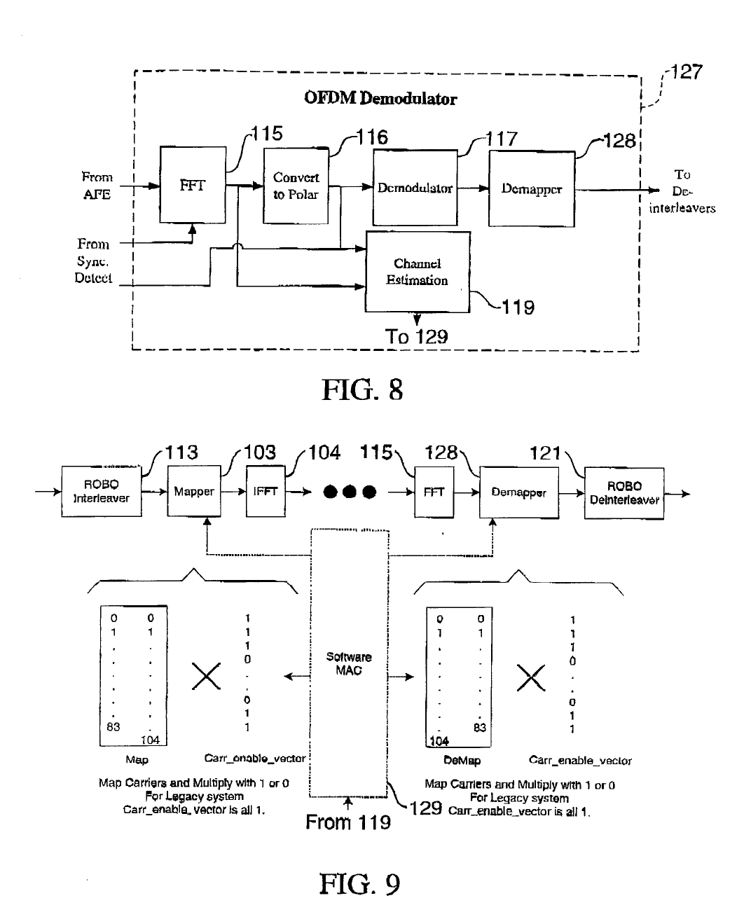

In order to enable this OFDM system for the invention, only minor changes are required. The only functionality that would need to be added relates to the mapper block and OFDM demodulator section of the system shown in FIG. 2. The mapper 103 would need to support two modes, based on the current configuration of the network. The first mode would be for the legacy system where there is no interference from an adjacent network segment. The second mode would be the invention enabled mode where carriers that are in the same frequency range as the adjacent network is using would be remapped to a higher frequency range. On the receiver side, the OFDM demodulator 127 would need to have a demapper block added. The demapper would basically have two modes as well. Based on the signals received out of the demodulator, along with the control data present, the demapper would decide whether to be in legacy mode, where the usable carriers are fed through directly to the deinterleavers, or to be in invention enabled mode, where the appropriate carriers would be remapped before sending to the deinterleavers. The modified OFDM demodulator 127 is shown an FIG. 8, with the demapper 128 added.

### DETAILS OF INVENTION

For a legacy system, a listing of the carrier numbers and frequencies are shown in Table 1.

TABLE 1
HomePlug Carrier Frequencies

| | Center | | Center | | |
|---|---|---|---|---|---|
| Carrier | Frequency | Carrier | Frequency | Carrier | Center |
| Number | MHz | Number | MHz | Number | Frequency |
| 0 | 4.4921875 | 28 | 9.9609375 | 56 | 15.4296875 |
| 1 | 4.6875 | 29 | 10.15625 | 57 | 15.625 |
| 2 | 4.8828125 | 30 | 10.3515625 | 58 | 15.8203125 |
| 3 | 5.078125 | 31 | 10.546875 | 59 | 16.015625 |
| 4 | 5.2734375 | 32 | 10.7421875 | 60 | 16.2109375 |
| 5 | 5.46875 | 33 | 10.9375 | 61 | 16.40625 |
| 6 | 5.6640625 | 34 | 11.1328125 | 62 | 16.6015625 |
| 7 | 5.859375 | 35 | 11.328125 | 63 | 16.796875 |
| 8 | 6.0546875 | 36 | 11.5234375 | 64 | 16.9921875 |
| 9 | 6.25 | 37 | 11.71875 | 65 | 17.1875 |
| 10 | 6.4453125 | 38 | 11.9140625 | 66 | 17.3828125 |
| 11 | 6.640625 | 39 | 12.109375 | 87 | 17.578125 |
| 12 | 6.8359375 | 40 | 12.3046875 | 68 | 17.7734375 |
| 13 | 7.03125 | 41 | 12.5 | 69 | 17.96875 |
| 14 | 7.2265625 | 42 | 12.6953125 | 70 | 18.1640625 |
| 15 | 7.421875 | 43 | 12.890625 | 71 | 18.359375 |
| 16 | 7.6171875 | 44 | 13.0859375 | 72 | 18.5546875 |
| 17 | 7.8125 | 45 | 13.28125 | 73 | 18.75 |
| 18 | 8.0078125 | 46 | 13.4765625 | 74 | 18.9453125 |
| 19 | 8.203125 | 47 | 13.671875 | 75 | 19.140625 |
| 20 | 8.3984375 | 48 | 13.8671875 | 76 | 19.3359375 |
| 21 | 8.59375 | 49 | 14.0625 | 77 | 19.53125 |
| 22 | 8.7890625 | 50 | 14.2578125 | 78 | 19.7265625 |
| 23 | 8.984375 | 51 | 14.453125 | 79 | 19.921875 |
| 24 | 9.1796875 | 52 | 14.6484375 | 80 | 20.1171875 |
| 25 | 9.375 | 53 | 14.84375 | 81 | 20.3125 |
| 26 | 9.5703125 | 54 | 15.0390625 | 82 | 20.5078125 |
| 27 | 9.765625 | 55 | 15.234375 | 83 | 20.703125 |

By extending the frequency range, we can come up with additional carriers that can be used above a legacy system, as shown it Table 2.

TABLE 2
Adding Carriers Above the Legacy Frequency Range

| Carrier # | Center Freq. | Tonemask |
|---|---|---|
| 0 | 4.4922 | |
| 1 | 4.6875 | |
| 2 | 4.8828 | |
| 3 | 5.0781 | |
| 4 | 5.2734 | |
| 5 | 5.4688 | |
| 6 | 5.6641 | |
| 7 | 5.8594 | |
| 8 | 6.0547 | |
| 9 | 6.2500 | |
| 10 | 6.4453 | |
| 11 | 6.6406 | |
| 12 | 6.8359 | |
| 13 | 7.0313 | X |
| 14 | 7.2266 | X |
| 15 | 7.4219 | |
| 16 | 7.6172 | |
| 17 | 7.8125 | |
| 18 | 8.0078 | |
| 19 | 8.2031 | |
| 20 | 8.3984 | |
| 21 | 8.5938 | |
| 22 | 8.7891 | |
| 23 | 8.9844 | |
| 24 | 9.1797 | |
| 25 | 9.3750 | |
| 26 | 9.5703 | |
| 27 | 9.7656 | |
| 28 | 9.9609 | |
| 29 | 10.1563 | X |
| 30 | 10.3516 | |
| 31 | 10.5469 | |
| 32 | 10.7422 | |
| 33 | 10.9375 | |
| 34 | 11.1328 | |
| 35 | 11.3281 | |
| 36 | 11.5234 | |
| 37 | 11.7188 | |
| 38 | 11.9141 | |
| 39 | 12.1094 | |
| 40 | 12.3047 | |
| 41 | 12.5000 | |
| 42 | 12.6953 | |
| 43 | 12.8906 | |
| 44 | 13.0859 | |
| 45 | 13.2813 | |
| 46 | 13.4766 | |
| 47 | 13.6719 | |
| 48 | 13.8672 | |
| 49 | 14.0625 | X |
| 50 | 14.2578 | X |
| 51 | 14.4531 | X |
| 52 | 14.6484 | |
| 53 | 14.8438 | |
| 54 | 15.0391 | |
| 55 | 15.2344 | |
| 56 | 15.4297 | |
| 57 | 15.6250 | |
| 58 | 15.8203 | |
| 59 | 16.0156 | |
| 60 | 16.2109 | |
| 61 | 16.4063 | |
| 62 | 16.6016 | |
| 63 | 16.7969 | |
| 64 | 16.9922 | |
| 65 | 17.1875 | |
| 66 | 17.3828 | |
| 67 | 17.5781 | |
| 68 | 17.7734 | |
| 59 | 17.9688 | X |
| 70 | 18.1641 | X |
| 71 | 18.3594 | |
| 72 | 18.5547 | |
| 73 | 18.7500 | |
| 74 | 18.9453 | |
| 75 | 19.1406 | |
| 76 | 19.3359 | |
| 77 | 19.5313 | |
| 78 | 19.7266 | |
| 79 | 19.9219 | |
| 80 | 20.1172 | |
| 81 | 20.3125 | |
| 82 | 20.5078 | |
| 83 | 20.7031 | |
| 84 | 20.8984 | X |
| 85 | 21.0938 | X |
| 86 | 21.2891 | X |
| 87 | 21.4844 | X |
| 88 | 21.6797 | |
| 89 | 21.8750 | |
| 90 | 22.0703 | |
| 91 | 22.2656 | |
| 92 | 22.4609 | |
| 93 | 22.6563 | |
| 94 | 22.8516 | |
| 95 | 23.0469 | |
| 96 | 23.2422 | |
| 97 | 23.4375 | |
| 98 | 23.6328 | |
| 99 | 23.8281 | |
| 100 | 24.0234 | |
| 101 | 24.2188 | |
| 102 | 24.4141 | |
| 103 | 24.6094 | |
| 104 | 24.8047 | |

A legacy system uses two functions in the system to disable use of specific carriers. One function is known as the Tonemask, which designates carriers that will never be used for transmission in a particular system. Table 2 also shows which carriers will be masked out of the system. The second function is known as the Tonemap, which designates which carriers to be used for each transmission on the power line based on a channel quality assessment of the channel. For the invention enabled mapper 103, we have two modes for carrier allocation:

TABLE 3
Carrier Mapping Table

| Legacy Carrier | Invention Carrier | Car enable vector in |
|---|---|---|
| Number | Number | Invention |
| 0 | 88 | 1 |
| 1 | 89 | 1 |
| 2 | 90 | 1 |
| 3 | 91 | 1 |
| 4 | 92 | 1 |
| 5 | 93 | 1 |
| 6 | 94 | 1 |
| 7 | 95 | 1 |
| 8 | 96 | 1 |
| 9 | 97 | 1 |
| 10 | 98 | 1 |
| 11 | 99 | 1 |
| 12 | 100 | 1 |
| 13 | 13 | 0 |
| 14 | 14 | 0 |
| 15 | 101 | 1 |
| 16 | 102 | 1 |
| 17 | 103 | 1 |
| 18 | 104 | 1 |
| 19 | 19 | 0 |
| 20 | 20 | 0 |
| 21 | 21 | 0 |
| 22 | 22 | 0 |
| 23 | 23 | 0 |
| 24 | 24 | 0 |
| 25 | 25 | 0 |
| 26 | 26 | 0 |
| 27 | 27 | 0 |
| 28 | 28 | 0 |
| 29 | 29 | 0 |
| 30 | 30 | 0 |
| 31 | 31 | 0 |
| 32 | 32 | 0 |
| 33 | 33 | 0 |
| 34 | 34 | 1 |
| 35 | 35 | 1 |
| 36 | 36 | 1 |
| 37 | 37 | 1 |
| 38 | 38 | 1 |
| 39 | 39 | 1 |
| 40 | 40 | 1 |
| 41 | 41 | 1 |
| 42 | 42 | 1 |
| 43 | 43 | 1 |
| 44 | 44 | 1 |
| 45 | 45 | 1 |
| 46 | 46 | 1 |
| 47 | 47 | 1 |
| 48 | 48 | 1 |
| 49 | 49 | 1 |
| 50 | 50 | 1 |
| 51 | 51 | 1 |
| 52 | 52 | 1 |
| 53 | 53 | 1 |
| 54 | 54 | 1 |
| 55 | 55 | 1 |
| 56 | 56 | 1 |
| 57 | 57 | 1 |
| 58 | 58 | 1 |
| 59 | 59 | 1 |
| 60 | 60 | 1 |
| 61 | 61 | 1 |
| 62 | 62 | 1 |
| 63 | 63 | 1 |
| 64 | 64 | 1 |
| 65 | 65 | 1 |
| 66 | 66 | 1 |
| 67 | 67 | 1 |
| 68 | 68 | 1 |
| 69 | 69 | 1 |
| 70 | 70 | 1 |
| 71 | 71 | 1 |
| 72 | 72 | 1 |
| 73 | 73 | 1 |
| 74 | 74 | 1 |
| 75 | 75 | 1 |
| 76 | 76 | 1 |
| 77 | 77 | 1 |
| 78 | 78 | 1 |
| 79 | 79 | 1 |
| 80 | 80 | 1 |
| 81 | 81 | 1 |
| 82 | 82 | 1 |
| 83 | 83 | 1 |

In FIG. 4 it is shown that the frequency allocation for the legacy device network segment is between frequency F4 and frequency F5. Therefore there is additional available frequency bandwidth that can be used in the legacy device network segment. Rather than shift up in frequency all of the carriers that would not allow communication with legacy devices, the carriers that are located in the overlapping band are re-mapped to the other available frequencies allocated to this network segment. This is illustrated in FIG. 6.

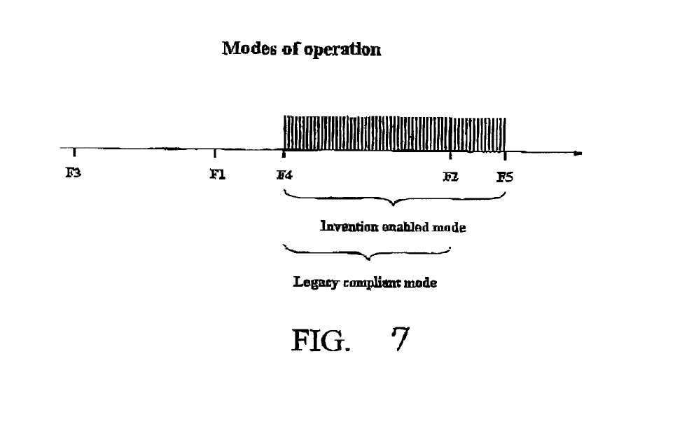

The substantial benefits of this invention are illustrated in FIG. 7. By re-mapping the conflicting carriers to other available frequencies, the original bandwidth available to legacy devices is preserved as much as possible in invention enabled devices. In addition, these invention enabled devices can communicate in an alternate mode with other compliant devices residing on the same network segment. Other compliant devices may able to disable the conflicting carriers, but will suffer a loss of available bandwidth that may be substantial.

For this system, carriers 0 to 16 can be remapped to the frequencies for carriers 88 to 104 Car₁₃ enable_vector shown in Table 3 will be used to determine which carriers to transmit on. The carriers for which Car_enable_vector=0, are multiplied by zero.

On the receiver side, the same method will be used by the demapper block. FIG. 9 shows a subset of the system, along with detail on the mapper 103 and the demapper 128. This Tonemap will be used for ROBO mode transmissions, however, for other modulation modes the Tonemap will be negotiated between two communicating units. Based upon the channel quality assessment, additional carriers may not be used. The control and decision making for the mapper and the demapper is handled by the software MAC 129. The Medium Access Controller will determine what mode to operate in and what carriers to ultimately use.

It should be noted that the number used in the mapper and demapper are examples. The ToneMask, mapper table, and enable_vector may change depending on the environment.

A broadband communication system will often have the need for substantial filtering requirements to comply with power radiation requirements as well as allowing for non-interference with other communication devices that may occupy areas of the communication spectrum. This often requires the use of complex filter designs which are large in size and costly. This invention resolves these issues while at the same time often allows for reduced complexity in the filter designs, therefore decreasing size and cost, as well as increased resolution of the received signal.

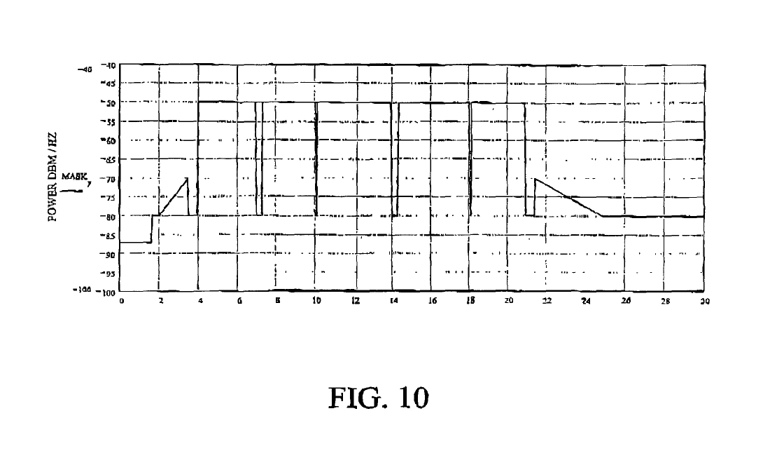

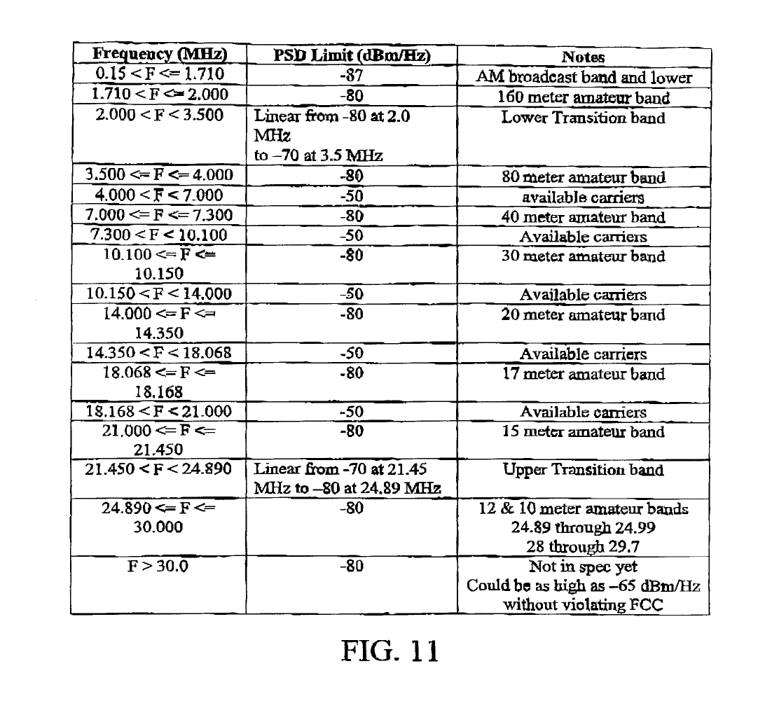

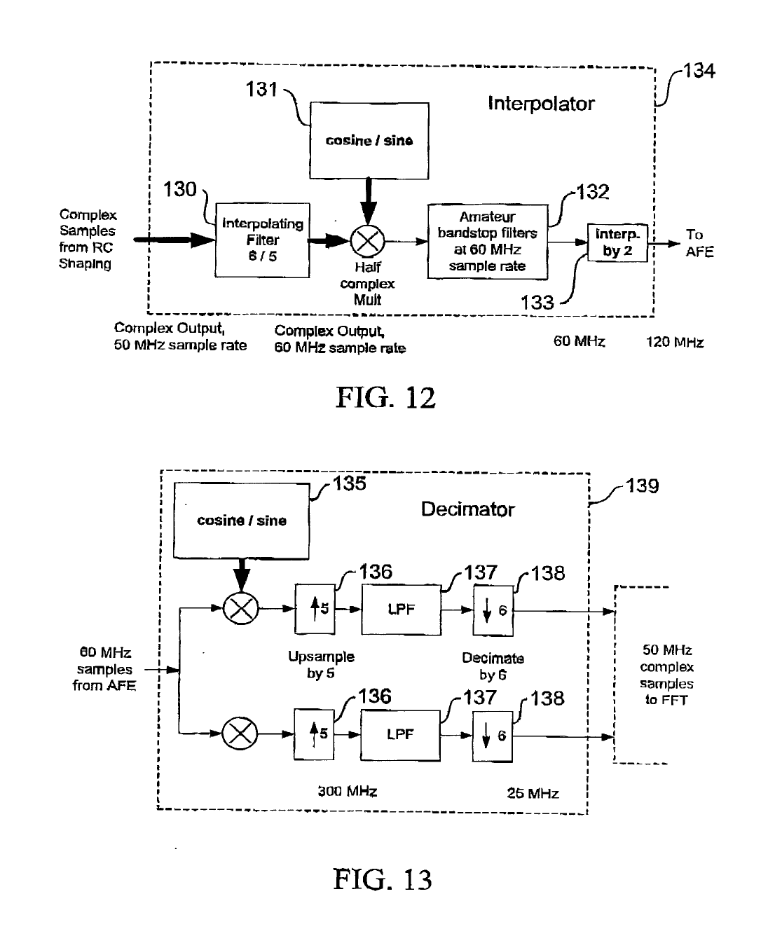

FIG. 10 illustrates a possible transmit spectrum mask requirement for a broadband communication system. It can be seen that there are various notches throughout the spectrum, as well as steep roll offs at the upper and lower limits of the spectrum. The power spectral density limits for the various filtering requirements are listed in the table of FIG. 11. It can be seen that steep notches are evident, which would require high-order notch filters to be used. FIG. 12 shows a possible design for the transmit path on an analog front end device. It can be seen that the normal sample rate defined by the communication protocol is being interpolated up to allow for simpler and smaller filters to be used. Interpolators are also used on the receive side, as shown in FIG. 13. Although the interpolators will add size to the design, this is outweighed by the reduction in size by being able to simplify the filter designs, as well as being able to meet the power spectral density limit requirements.

Taking the system diagram in FIG. 2 as a basis, there are changes made to both the transmitter and receiver portions to enable the invention. For the transmitter, an interpolator 134 is added between the RC shaping 107 and the AFE 114. The interpolator detail is shown in FIG. 12. The complex output (having both real and imaginary parts) from the RC shaping 107 with a 50 MHz sampling rate is converted to a complex output with a 60 MHz sampling rate by the interpolating filter 130. This complex output is then combined to a real output by the cosine/sine 131 and the notches required are filtered out by the amateur bandstop filters 132. This output is then interpolated up to 120 MHz (133) and sent to the AFE. For the receiver side, there is a decimator 139 added between the AFE 114 and the FFT 115. This block is detailed in FIG. 13. The samples taken of the Powerline at 60 MHz will be converted to a complex output by the cosine/sine 135. To prevent aliasing of the input signals at frequencies between 20 and 25 MHz, the input signal is also shifted in frequency (135). Each path will then be upsampled by 5 (136), put through a low pass filter (137), and then decimated by 6 (138) to arrive at an output sampled at 50 MHz for input into the FFT 115.

Decoupling of the frequency spacing and sampling rate from the protocol timing allows for adjustments of the frequency range used, carrier frequency spacing, and number of carriers used.

What is claimed:

1. Apparatus for generating and transmitting over a transmission medium a plurality of radio frequency carriers modulated with data signals, the carriers having frequencies in two different, separated frequency ranges, one range higher than the other range, receiving apparatus for receiving and demodulating the carriers transmitted over the transmission medium and having a detector responsive to radio frequency carriers with a frequency intermediate said frequency ranges and a selector coupled to the detector and to the transmitting apparatus for enabling the generation of a plurality of modulated radio frequency carriers having frequencies in one of the two different frequency ranges.

2. Apparatus as set forth in claim 1, wherein the one of the two different frequency ranges is the higher frequency range.

3. Apparatus as set forth in claim 2, wherein the transmission medium is a power line.

4. Apparatus as set forth in claim 3, wherein the power line has interconnected segments and the intermediate carriers are supplied to one segment and the generating and transmitting apparatus and the receiving apparatus are coupled to a different segment.

5. Apparatus as set forth in claim 1, wherein the apparatus for generating and transmitting comprises first means for sampling data signals at a first rate, second means coupled to the first means for providing data signals sampled at a second rate higher than the first rate carrier generating means for generating a plurality of carriers having frequencies different from the sampling rate, modulating mean coupled to the second means and to the carrier generating means for modulating the plurality of carriers with the data signals sampled at the second rate.

6. Apparatus as set forth in claim 5, wherein the receiving apparatus comprises receiving means for receiving the plurality of carriers modulated with the data signals sampled at the second rate, frequency converting means coupled to the receiving means for increasing the frequency of the received carriers and decimating means coupled to the frequency converting means for converting the signals at the output of the frequency converting means to data signals sampled at the first rate.

7. A transmitter having a radio frequency carrier generator for generating a plurality of radio frequency carriers to be transmitted over a transmission medium, the carriers having frequencies in a first range, a modulator coupled to the generator for modulating the carriers with data signals, a mapper coupled to the modulator for selecting the carriers to be modulated dependent on the presence of electrical signals supplied to the transmission medium by another transmitter and having frequencies in a second range which overlaps, but is not coextensive with, said first range, said mapper changing the frequencies of the carriers in said first range which overlap the frequencies of the electrical signals in the second range to different frequencies.

8. A transmitter as set forth in claim 7, wherein the different frequencies are higher frequencies.

9. A transmitter as set forth in claim 8, wherein the lower end of the second range overlaps the upper end of the fast range and the higher frequencies are at the upper end of the second range.

10. Apparatus for generating and transmitting over a transmission medium a plurality of radio frequency carrier modulated with data signals comprising first means for sampling data signals at a first rate, second means coupled to the first means for providing data signals sampled at a second rate higher than the first rate, carrier generating means for generating a plurality of carriers having frequencies different from the sampling rate, modulating means coupled to the second means and to the carrier generating means for modulating the plurality of carriers with the data signals sampled at the second rate.

11. Receiving apparatus comprising receiving means for receiving a plurality of carriers modulated with the data signals sampled at a first rate, frequency converting means coupled to the receiving means for increasing the frequency of the received carriers and decimating means coupled to the frequency converting means for converting the signals at the output of the frequency converting means to data signals sampled at a second rate lower than said first rate.

12. In a power line communication system in which data modulated radio frequency carriers from two different sources are transmitted by the power line, the range of frequencies of the carriers from one source partially overlapping the range of frequencies of the carriers from the other source, the method of reducing interference between the carriers from the one source and the carriers from the other source which comprises:
monitoring the power line at the one source to determine the presence or absence of carriers at overlapping frequencies from the other source; and
when the presence of carriers at overlapping frequencies from the other source are detected shifting the frequencies of the carriers from the one source which overlap the frequencies of the carriers of the other source to frequencies other than the overlapping frequencies.

13. The method as set forth in claim 12, wherein the upper end of the range of carrier frequencies of the one source overlaps the lower end of the range of carrier frequencies of the other source.

14. The method as set forth in claim 13, wherein the frequencies of the carriers in the upper end of the range of frequencies of the carrier frequencies of the one source are shifted to higher frequencies.

15. The method as set forth in claim 14, wherein the higher frequencies are in the range of frequencies of the carriers of the other source.
